(19) United States
(12) Patent Application Publication
(10) Pub. No.: US 2012/0194836 A1
(43) Pub. Date: Aug. 2, 2012

(54) IMAGE FORMING APPARATUS AND PROGRAM

(75) Inventor: Fukutoshi Uchida, Kanagawa (JP)

(73) Assignee: RICOH COMPANY, LIMITED, Tokyo (JP)

(21) Appl. No.: 13/353,881

(22) Filed: Jan. 19, 2012

(30) Foreign Application Priority Data
Jan. 27, 2011 (JP) 2011-014708

(51) Int. Cl. G06F 3/12

(52) U.S. Cl. 358/1.13

(57) ABSTRACT

An image forming apparatus includes: a device that performs a mechanical operation; a device control unit that controls the mechanical operation of the device; a process control unit that establishes communication with the device control unit and controls a process related to the device under the established communication; and an activation method setting unit that sets information on an activation method which is performed when the device control unit activates the device. The device control unit is provided with a unit that refers to information, which is set by the activation method setting unit before the communication is established by the process control unit, on an activation method of the device after a predetermined time elapses, and activates the device based on the reference information related to the activation method of the device.

### CROSS-REFERENCE TO RELATED APPLICATIONS

The present application claims priority to and incorporates by reference the entire contents of Japanese Patent Application No. 2011-014708 filed in Japan on Jan. 27, 2011.

### BACKGROUND OF THE INVENTION

1. Field of the Invention

The present invention relates to an image forming apparatus which includes: a facsimile; a printer; and a copying machine, and a program which causes a computer to control the image forming apparatus.

2. Description of the Related Art

Recently, an image forming apparatus (referred to as a “multifunction peripheral (MFP)”) has been widely used in which a plurality of functions of copying, facsimile communication, printing, scanning, and the like are combined.

In such a type of image forming apparatus, after the power has been supplied and a given time elapses without any operation, the apparatus changes its state in order of higher energy saving state, for example, from standby mode to preheating mode, to low power mode, and to sleep mode.

When the image forming apparatus is in an energy saving standby state, for the purpose of using functions of copying, printing, or communicating, the system is configured to regain its functions when a user presses down a power button provided on an operation panel, sets documents on an automatic document feeder (ADF), performs a plate pressing operation, or when electronic data is received from an external terminal.

In order for the functions of the system to regain an operable state, only mechanisms (the scanner device, the printing device, the communication device, or the like) for implementing necessary functions (applications) such as copying and printing are activated in consideration of energy saving efficiency, thereby suppressing power consumption.

However, in order to cause only the necessary functions to regain an operable state, the user should wait while the controller which controls the entire image forming apparatus is activated. For this reason, there is a concern that the activation of the engine of the device which greatly influences the activation time of the image forming apparatus may be delayed.

Therefore, there is an image forming apparatus (for example, see Japanese Patent Application Laid-open No. 2007-301765) proposed in the related art, in which, by instructing the engine controlling unit to activate the engine before the establishment of the communication between the controller and the engine controlling unit which is responsible for the mechanical operation of the engine of the device, the engine controlling unit starts the activation of the engine without waiting for the activation of the controller, so as to shorten the activation time.

However, in the above-mentioned image forming apparatus according to the related art, there is a problem in that, when it takes much time to activate the controller, a dedicated signal for indicating the activation method of the engine may not be appropriate for the engine controller. Therefore, even though the activation of the engine is advanced, it is difficult to implement an originally intended activation method.

### SUMMARY OF THE INVENTION

It is an object of the present invention to at least partially solve the problems in the conventional technology.

According to an aspect of the present invention an image forming apparatus includes: a device that performs a mechanical operation; a device control unit that controls the mechanical operation of the device; a process control unit that establishes communication with the device control unit and controls a process related to the device under the established communication; and an activation method setting unit that sets information on an activation method which is performed when the device control unit activates the device, and the device control unit is provided with a unit that refers to information, which is set by the activation method setting unit before the communication is established by the process control unit, on an activation method of the device after a predetermined time elapses, and activates the device based on the reference information related to the activation method of the device.

According to another aspect of the present invention a computer-readable recording medium having computer readable program codes embodied in the medium for processing information in an information processing apparatus that includes a generating unit, and an output unit, the program codes when executed causes a computer to execute: performing a mechanical operation by a mechanical operation device; controlling operation of the mechanical operation device by a device control unit; establishing communication with the device control unit and controlling a process related to the mechanical operation device under the established communication; and setting information on an activation method which is performed when the device control unit activates the device, and the device control unit is provided with a unit that refers to information, which is set by the activation method setting unit before the communication is established by the process control unit, on an activation method of the device after a predetermined time elapses; and activating the device based on the reference information related to the activation method of the device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram illustrating the structure of main functions of the control unit of a plotter apparatus illustrated in FIG. 2;

FIG. 2 is a diagram illustrating the outward appearance of a multifunction printer (MFP) according to an embodiment of the invention; and

FIG. 3 is a flowchart illustrating a process performed by the control unit of the plotter apparatus illustrated in FIG. 2 at the time of the activation of an engine.

### DETAILED DESCRIPTION OF THE PREFERRED EMBODIMENTS

Herein below, embodiments of the invention will be specifically described with reference to the drawings.

FIG. 2 is a diagram illustrating the outward appearance of an MFP according to this embodiment.

The MFP includes a printer, a copying machine, a plotter apparatus 1 which is an image forming apparatus, sheet storage devices 2 and 3, and sheet post-processing devices 4 to 6.

The plotter apparatus 1, for example, is configured with an electrophotographic recording device or an ink jet recording device. The plotter apparatus 1 prints image information onto a sheet fed from the sheet storage devices 2 and 3, and discharges the printed sheet through a sheet discharging port so that the printed sheet will be conveyed to the sheet post-processing device 4 disposed at the later stage.

The sheet storage devices 2 and 3 are used to store the sheets on which the image information is to be printed. The sheet storage device 2 is connected to the lower side of the plotter apparatus 1, which is a storage device having a smaller sheet capacity than the sheet storage device 3. The sheet storage device 3 is connected to the plotter apparatus 1 in parallel, which is a storage device having a large sheet capacity.

These sheet storage devices 2 and 3 are provided with a plurality of sheet feeding stages (any one of the stages stores sheets of the same size) in which sheets of different sizes are stored respectively, so that these sheets are fed to the plotter apparatus 1.

The sheet post-processing devices 4 to 6 are devices which perform post-processing, various types of finishing processes, on the sheet discharged from the plotter apparatus 1 which has the image information printed thereon.

In this way, an image forming apparatus according to this embodiment is configured such that the sheet post-processing device is connected to the plotter apparatus 1 so as to perform a plurality of different kinds of processes as the post-processing.

Examples of the sheet post-processing devices 4 to 6 include: an insertion device for inserting a cover sheet or an interleaf for book binding; a punching device for punching the sheets; a folding device for folding the sheets for book binding; a staple device for stapling a bundle of multiple printed sheets; a book binding device for tape binding, ring binding, and sure binding; and a cutting device for cutting the bound sheets into a final size.

While not illustrated in the drawing, a consumable goods storage unit is further provided to store consumable goods, for example, a stapler for a stapling process, an adhesive for non-line stitch binding, tape for tape binding, rings for ring binding, bind strips for sure binding.

Further, in a case where the staple device is included, when a staple is cut into an appropriate size according to the number of printed materials to be bound, the staple swarf is generated in the stapling process. In a case where the punch device is included, when the printed sheet is punched in the punch process, the punch swarf is generated. In a case where the binding device is included, when a milling process of three-edge cutting or non-line stitching is performed in the book binding process, the cutting swarf is generated. Therefore, a residue recovering unit is further provided to store the residual swarf such as the staple swarf, the punch swarf, and the cutting swarf.

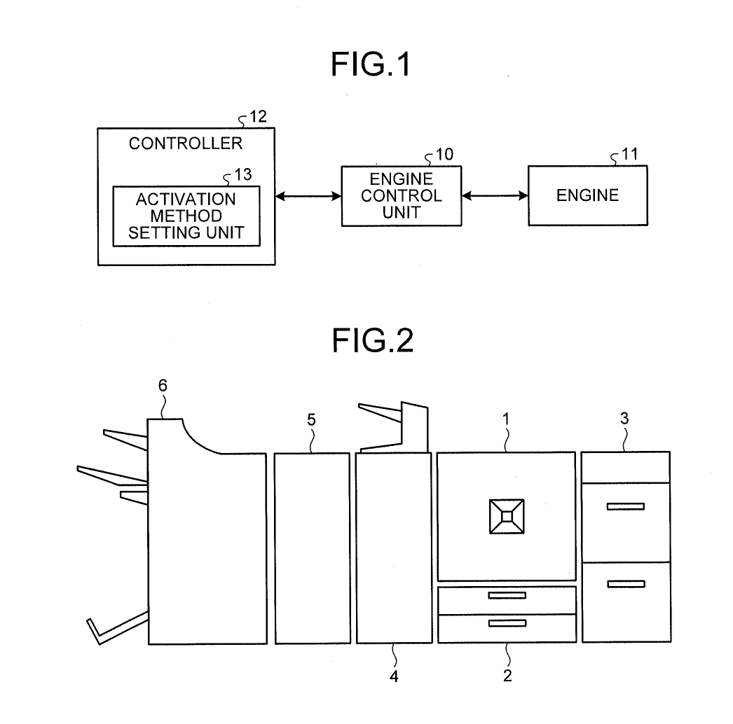

FIG. 1 is a functional block diagram illustrating the structure of main functions of the control unit of a plotter apparatus 1 illustrated in FIG. 2.

The control unit is realized by a micro computer including a central processing unit (CPU), a read only memory (ROM), and a random access memory (RAM). The CPU executes a program stored in the ROM using the RAM as a work area, so that the functional sections of an engine control unit 10 and a controller 12 are realized.

The controller 12 serves as a process control unit which is responsible for controlling the entire MFP, establishes a communication with the engine control unit 10, and controls the processes of engines of various devices such as a scanner and a printer under the established communication. In addition, the controller 12 further includes an activation method setting unit 13. The activation method setting unit 13 serves as an activation method setting unit which sets information on an activation method when the engine control unit 10 activates a device.

Before the communication is established between the controller 12 and a device control unit that controls mechanical operations of the devices, the engine control unit 10 refers to the information on the activation method of the engines of various devices, such as a scanner and a printer, which is set by the activation method setting unit 13 after a predetermined standby time (wait time) elapses, and accomplishes the function of a unit that activates the devices according to the reference information on the activation method of the devices.

Next, the process which is performed by the MFP at the time of the activation of an engine 11 will be described.

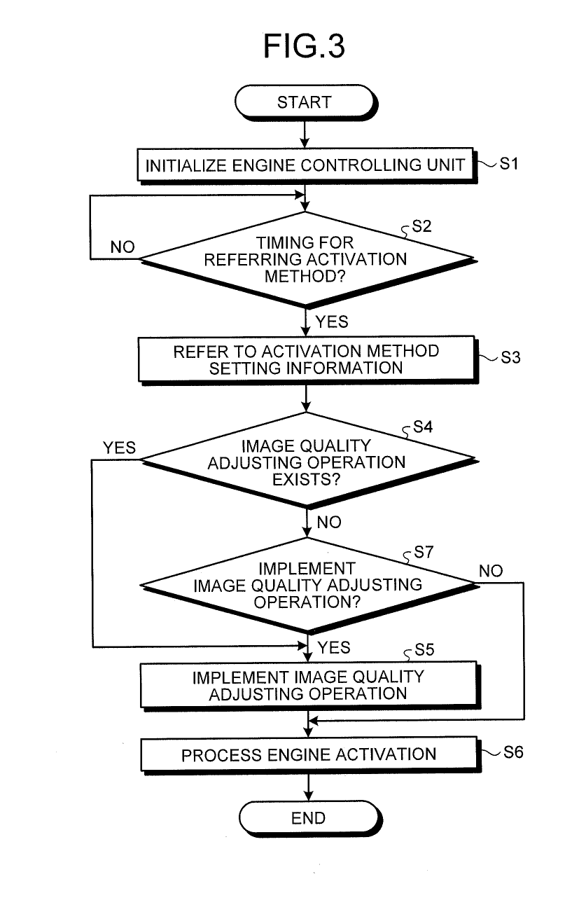

FIG. 3 is a flowchart illustrating the process performed by the MFP at the time of the activation of the engine 11.

The engine control unit 10 initializes a program and performs an initialization process of only checking the state whether or not the hardware of the engine 11 of FIG. 1 can be driven in Step (denoted by “S” in the drawing) 1.

Subsequently, setting information on the activation method (whether or not it is necessary to perform an adjustment operation) of the engine 11 is checked. In this case, since the setting information is set by the activation method setting unit 13 on the basis of the determination of the controller 12 of FIG. 1, if the controller 12 per se is not yet activated, the initial value of the information is maintained.

For this reason, in Step 2, the engine control unit 10 waits for a time until a predetermined standby time elapses, and then determines whether or not the wait time has elapsed and hence whether or not it is timing when to refer to the activation method setting. When it is determined that it is not the timing when to refer to the activation method setting (No in Step 2), the determination process is repeated. When it is determined that it is the timing when to refer to the activation method setting (Yes in Step 2), the procedure proceeds to Step 3.

In this way, by referring to the activation method setting after a lapse of a predetermined period of time, an erroneous activation of the engine may be suppressed on the basis of information when the activation method is not set due to the activation delay of the controller 12.

In Step 3, the activation method setting unit 13 of the controller 12 illustrated in FIG. 1 refers to information on the activation method setting. In Step 4, it is determined whether or not the implementation of an image quality adjusting operation is set in the information on the activation method setting of the activation method setting unit 13 of the controller 12 illustrated in FIG. 1.

In Step 4, if it is determined that the image quality adjusting operation is set to be implemented (Yes in Step 4), the image quality adjusting operation is implemented in Step 5. In Step 6, the engine 11 illustrated in FIG. 1 immediately performs an activation process to end this procedure, and the state is changed into a printable state.

Further, in Step 4, if it is determined that the image quality adjusting operation is not implemented (No in Step 4), it is determined whether or not the image quality adjusting operation is implemented as the determination on the implementation of the adjusting operation in Step 7.

As described above, when the information on the activation method setting indicates that the image quality adjusting operation is not set, it is determined whether or not the image quality adjusting operation is implemented on the basis of information (a threshold is set to an amount of change in temperature of the engine 11 or a difference in a date and time when the previous adjustment is implemented on the engine 11) stored in the engine control unit 10 in order to be prepared for the failure of the setting on the activation method due to the activation delay of the controller 12.

In Step 7, when it is determined that the image quality adjusting operation is set to be implemented (Yes in Step 7), the image quality adjusting operation is implemented in Step 5. In Step 6, the engine 11 illustrated in FIG. 1 immediately performs an activation process to end this procedure, and the state is changed into a printable state.

Further, in Step 7, when it is determined that the image quality adjusting operation is set not to be implemented (No in Step 7), in Step 6 the engine 11 illustrated in FIG. 1 immediately performs the activation process to end this procedure, and the state is changed into a printable state.

In this way, in a case where the activation of the engine starts before the activation of the controller starts, the erroneous activation of the engine may be suppressed.

In addition, in a case where the activation of the controller is delayed, the engine control unit determines the activation method to activate the engine without referring to the setting of the controller, so that an appropriate activation process can be performed.

An image forming apparatus according to the invention can suppress the erroneous activation of an engine, when the activation of the engine starts before the activation of a controller.

In addition, a program according to the invention causes a computer to control the image forming apparatus such that the erroneous activation of the engine can be suppressed even when the activation of the engine starts before the activation of the controller.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a device that performs a mechanical operation;
a device control unit that controls the mechanical operation of the device;
a process control unit that establishes communication with the device control unit and controls a process related to the device under the established communication; and
an activation method setting unit that sets information on an activation method which is performed when the device control unit activates the device,
wherein the device control unit is provided with a unit that refers to information, which is set by the activation method setting unit before the communication is established by the process control unit, on an activation method of the device after a predetermined time elapses, and activates the device based on the reference information related to the activation method of the device.

2. The image forming apparatus according to claim 1, wherein the device control unit is provided with a unit that immediately activates the device when the information on the activation method of the device is referred to.

3. The image forming apparatus according to claim 1, wherein the device control unit is provided with a unit that determines the activation method of the device so as to activate the device based on the confirmation result when the reference information is not set in connection to the activation method of the device.

4. The image forming apparatus according to claim 3, wherein the determination on the activation method of the device is performed based on the information related to the activation method of the device.

5. The image forming apparatus according to claim 4, wherein the information on the activation method of the device corresponds to an amount of change in temperature of the device.

6. The image forming apparatus according to claim 4, wherein the information on the activation method of the device corresponds to a date and time when a previous adjusting operation of the device is implemented.

7. A computer-readable recording medium having computer readable program codes embodied in the medium for processing information in an information processing apparatus that includes a generating unit, and an output unit, the program codes when executed causes a computer to execute:
performing a mechanical operation by a mechanical operation device;
controlling operation of the mechanical operation device by a device control unit;
establishing communication with the device control unit and controlling a process related to the mechanical operation device under the established communication; and
setting information on an activation method which is performed when the device control unit activates the device,
wherein the device control unit is provided with a unit that refers to information, which is set by the activation method setting unit before the communication is established by the process control unit, on an activation method of the device after a predetermined time elapses; and
activating the device based on the reference information related to the activation method of the device.
